(19) United States
(12) Patent Application Publication
(10) Pub. No.: US 2004/0128493 A1
(43) Pub. Date: Jul. 1, 2004

(54) Methods and apparatus for providing a firmware defined radio

(76) Inventors: Vincent J. Zimmer, Federal Way, WA (US); Michael A. Rothman, Gig Harbor, WA (US); Rahul Khanna, Beaverton, OR (US); Mark S. Doran, Olympia, WA (US)

Correspondence Address: GROSSMAN & FLIGHT LLC, Suite 4220, 20 North Wacker Drive, Chicago, IL, 60606-6357, US

(21) Appl. No.: 10/330,802

(22) Filed: Dec. 27, 2002

(51) Int. Cl. G06F 15/177

(52) U.S. Cl. 713/1

(57) ABSTRACT

Methods and apparatus for providing a firmware defined radio are disclosed. In an example, a machine readable medium includes instructions that are adapted to be read by a machine to enable the machine to receive data via wireless communications in a pre-boot environment.

### TECHNICAL FIELD

The present disclosure pertains to communication and processing systems and, more particularly, to methods and apparatus for providing a firmware defined radio.

### BACKGROUND

When a processor such as, for example, a processor in a conventional personal computer, is powered up, the processor executes a reset vector, which points the processor to firmware code stored in a boot block of a memory (e.g., a portion of a flash memory). The instructions in the boot block impart functionality to the processor and inform the processor of the location of further firmware instructions in memory, such as flash memory, to be executed by the processor.

After a number of firmware instructions have been executed, the firmware instructs the processor to boot an operating system. As will be readily appreciated by those having ordinary skill in the art, an operating system may be booted from any one of a number of different media types or devices. For example, the processor may boot an operating system from a removable media such as a floppy disk or from a hard disk that is coupled to the processor. Additionally, if the system in which the processor is installed includes a network interface though which the processor is coupled to other processors, the operating system may be booted remotely over a network. Network interfaces may take the form of Ethernet network cards, local area network (LAN) cards or wireless cards that provide network connectivity via wireless link.

With the advent and proliferation of wireless networking devices that connect to, for example, LANs, wide area networks (WANs) and the like, remote access, remote control and remote booting of processors over a network has become highly desirable and cost effective. For example, wireless connections for networks based on digital communication techniques, such as time-division multiple access (TDMA) and code-division multiple access (CDMA), are widely available. Communications using TDMA and CDMA techniques may be carried out at any number of different frequencies. For example, communication standards such as the Bluetooth standard, the IS-95 standard and the IS-136 standard operate at frequencies of 2,400 megahertz (MHz), 800 MHz and 800 MHz or 1800 MHz, respectively. Other communication systems, such as the global system for mobile communications (GSM), operate at a number of different frequencies, such as 900 MHz, 1800 MHz and 1900 MHz. Most recently, the third generation of communication devices and infrastructure (3G) promises world-wide wireless connectivity using a number of different frequencies.

As wireless communication standards are promulgated, the free market decides which wireless standards and products will be accepted. For example, early cellular technology was based, almost exclusively, on the TDMA standard (e.g., IS-136), while, today, cellular technology is moving toward an almost exclusively CDMA-based platform (e.g., IS-95, 2.5 generation (2.5G) or 3G). In the period when standards are implemented and gain acceptance or are rejected by the marketplace, consumers purchase equipment that may quickly become outdated or unsupported due to the communication standard on which the equipment is based. Accordingly, wireless networking equipment may have a shorter life span than the hardware being networked by the wireless equipment. For example, a built-in wireless networking card in a server, notebook computer or handheld device may become antiquated before the device itself is useless. This situation leaves the consumer with a device having useful functionality, but limited wireless capability.

### BRIEF DESCRIPTION OF THE DRAWINGS

FIG. 1 is a diagram of an example wireless communication system.

FIG. 2 is a diagram of an example processor system that may be found in the remote device or the server of FIG. 1.

FIG. 3 is a diagram of an example firmware defined radio implemented on the processor of FIG. 2.

FIG. 4 is a block diagram of an example technology module of FIG. 3.

FIG. 5 is a flow diagram of an example boot process that may be carried out by the example processor system of FIG. 2.

### DETAILED DESCRIPTION

Although the following disclosed example systems include, among other components, firmware or software executed on hardware, it should be noted that such systems are merely illustrative and should not be considered as limiting. For example, it is contemplated that any or all of these hardware, firmware and software components could be embodied exclusively in dedicated hardware, exclusively in software, exclusively in firmware or in some suitable combination of hardware, firmware and/or software. Accordingly, while the following describes example systems, persons of ordinary skill in the art will readily appreciate that the examples are not the only way to implement such systems.

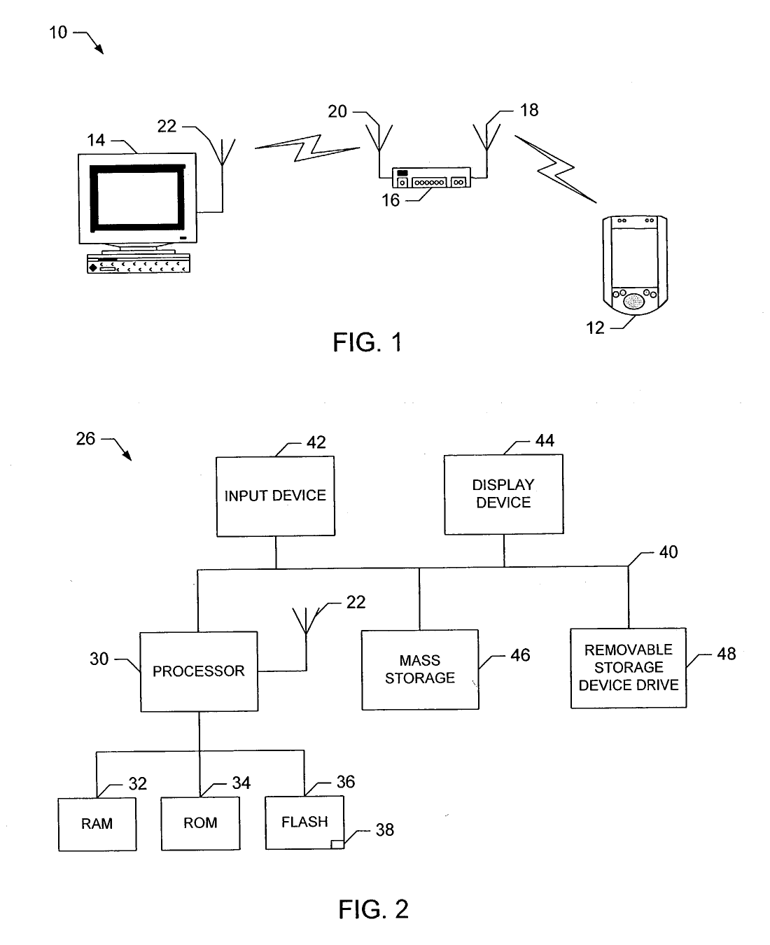

As shown in FIG. 1, an example communication system 10 includes a remote device 12 that communicates with a server 14 via a wireless hub 16. The wireless hub 16 includes a first antenna 18 and a second antenna 20 that facilitate information exchange with the remote device 12 and the server 14, respectively. The server 14 also includes an antenna 22. Although not shown in FIG. 1, the remote device 12 includes an antenna that is disposed within the housing of the remote device 12.

The remote device 12 may be any computing device in which network communications with wireless functionality is desirable. For example, the remote device 12 could be a personal digital assistant (PDA), a notebook computer, a telephone, a pager or any other suitable device. In some situations, the remote device 12 could be another computer that is to be administered, booted and remotely managed by the server 14. The server 14 could be any computing device with which networking would be desirable. For example, the server 14 could be a conventional desktop computer, a high performance data server, an Internet hosting computer or any other suitable device. In one particular example, the server 14 could be an administration station that personnel could use to remotely administer, boot or control the remote device 12. The wireless hub 16 may be, for example, a wireless home network, such as a Linksys® Wireless Access Point Router, or the like. Additionally, the wireless hub 16 could be a portion of cellular infrastructure to which the server 14 may be hard-wired.

In an example operation mode, the remote device 12 makes requests for information from the server 14 via the wireless hub 16. The server 14 prepares the information requested by the remote device 12 and forwards it to the remote device 12 via the wireless hub 16. In another example operation mode, the server 14 remotely controls or administers the remote device 12. In such an operation, the server 14 could control the pre-boot execution of the remote device 12. The communications between the remote device 12, the wireless hub 16 and the server 14 may be, for example, TDMA or CDMA-type digital signals. Additionally, the communications between the remote device 12, the wireless hub 16 and the server 14 may take place at any suitable frequency range (e.g., 800 MHz, 900 MHz, 1800 MHz, 1900 MHz and the like).

As shown in FIG. 2, an example processor system 26, which may be found in either the server 14 or the remote device 12 of FIG. 1, includes a processor 30 having associated memories, such as a random access memory (RAM) 32, a read only memory (ROM) 34 and a flash memory 36. The flash memory 36 of the illustrated example includes a boot block 38. The processor 30 is coupled to an interface, such as a bus 40 to which other components may be interfaced. In the illustrated example, the components interfaced to the bus 40 include an input device 42, a display device 44, a mass storage device 46 and a removable storage device drive 48. The removable storage device drive 48 may include associated removable storage media (not shown), such as magnetic or optical media.

The example processor system 26 may be, for example, the server 14, the remote device 12, a conventional desktop personal computer, a notebook computer, a workstation or any other computing device. The processor 30 may be any type of processing unit, such as a microprocessor from the Intel® Pentium® family of microprocessors, the Intel® Itanium® family of microprocessors, and/or the Intel XScale® family of processors. The processor 30 may include on-board analog-to-digital (A/D) and digital-to-analog (D/A) converters.

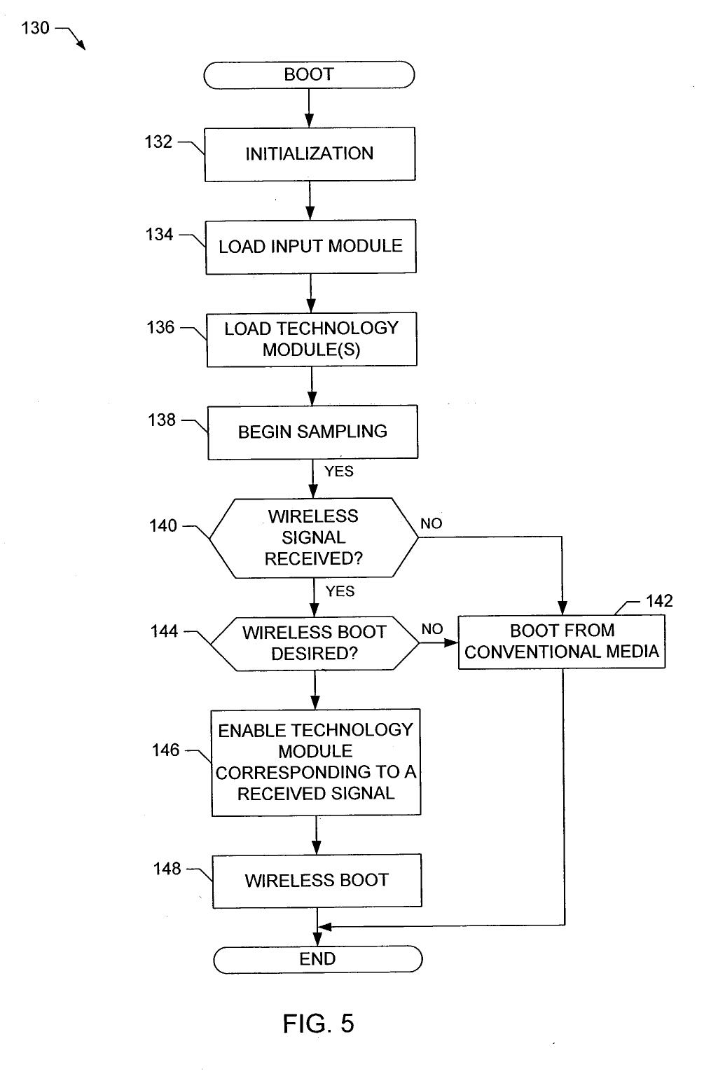

The memories 32, 34 and 36 that are coupled to the processor 30 may be any suitable memory devices and may be sized to fit the storage and operational demands of the system 26. In particular, the flash memory 36 may be a non-volatile memory that is accessed and erased on a block-by-block basis and that, as described in conjunction with FIG. 5, stores instructions that cause the processor 30 to act, in a pre-boot environment, as a firmware defined radio suitable to exchange information in a wireless manner across a number of different communication frequencies with a number of different protocols. The frequencies and protocols that may be used to exchange information are defined by the firmware instructions stored in the flash memory 36.

The input device 42 may implemented by a keyboard, a mouse, a touch screen, a track pad or any other known device that enables a user to provide information to the processor 30.

The display device 44 may be, for example, a liquid crystal display (LCD) monitor, a cathode ray tube (CRT) monitor or any other suitable device that acts as an interface between the processor 30 and a user. The display device 44 as pictured in FIG. 2 includes any additional hardware required to interface a display screen to the processor 30.

The mass storage device 46 may be, for example, a conventional hard drive or any other magnetic or optical media that is readable by the processor 30. Optionally, the mass storage device 46, in the case of a small form-factor device, such as the remote unit 12 of FIG. 1, may be omitted in favor of additional RAM 32.

The removable storage device drive 48 may, for example, be an optical drive, such as a compact disk-recordable (CD-R) drive, a compact disk-rewritable (CD-RW) drive, a digital versatile disk (DVD) drive or any other optical drive. The removable storage device drive 48 may alternatively be, for example, a magnetic media drive. If the removable storage device drive 48 is an optical drive, the removable storage media used by the drive 48 may be a CD-R disk, a CD-RW disk, a DVD disk or any other suitable optical disk. On the other hand, if the removable storage device drive 48 is a magnetic media device, the removable storage media used by the drive 48 may be, for example, a diskette or any other suitable magnetic storage media.

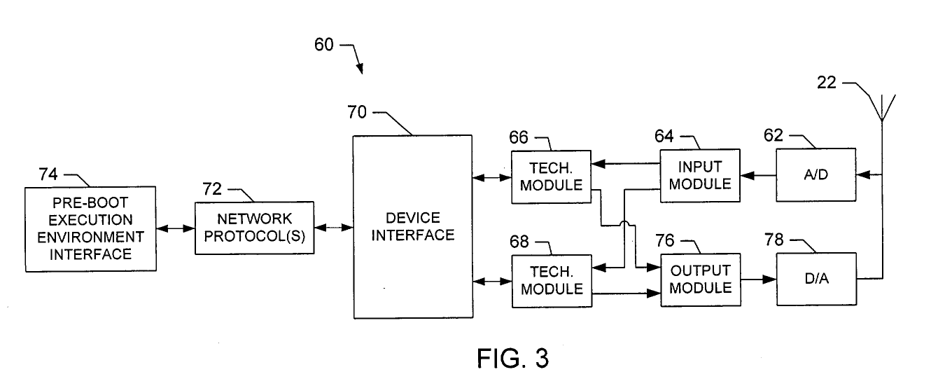

As described below in conjunction with FIGS. 3-5, firmware, which may be stored in the flash memory 36, enables the processor 30 to operate as a firmware defined radio in pre-boot and post-boot environments. This functionality is imparted to the processor 30 through firmware that is stored in the flash 36 and read by the processor 30 on boot of the processor. Once the processor 30 has the ability to receive wireless information from, for example, the wireless hub 16, the processor 30 may be remotely booted, remotely administered or managed in any desired manner. Advantageously, the firmware of the processor system 26 may be changed or updated as new communication protocols are desired. The disclosed architecture eliminates the need to purchase new hardware when wireless communication using a new protocol or frequency band is desired. Rather, firmware upgrades may be used to augment communication functionality.

For convenience and ease of explanation, the example processor system 26 of FIG. 2 is referred to hereinafter with respect to containing certain functionality or executing certain hardware and/or firmware instructions. Those having ordinary skill in the art will readily recognize that either or both of the remote device 12 and the server 14 could include the example processor system 26. Accordingly, the description provided in conjunction with FIG. 2 is applicable to either or both of the remote device 12 and the server 14.

An example firmware defined radio 60, as shown in FIG. 3, is the result of the processor 30 (FIG. 2) executing firmware instructions in a pre-boot environment. The firmware defined radio 60 includes a receive path and a transmit path, each of which is coupled to the antenna 22. In the receive path, the antenna 22 is coupled to an A/D converter 62 that samples, at pre-defined intervals, the analog signal received from the antenna 22. The samples from the A/D converter 62 are coupled to an input module 64 that processes the samples by digitally filtering and interpolating between the samples. The rate at which the A/D converter 62 samples the incoming signal is dictated by a high speed sampling module contained in the input module 64. The filtering carried out by the input module 64 may be carried out by a finite impulse response (FIR) digital filter.

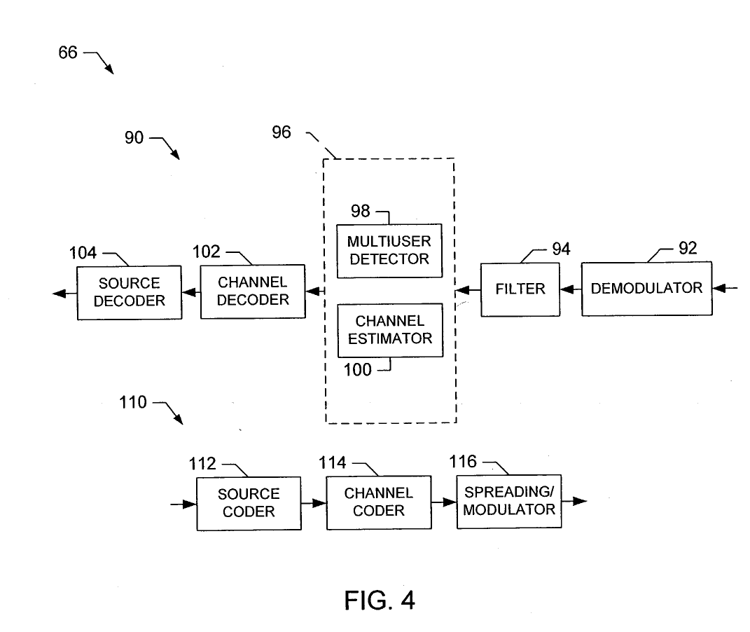

The processed samples are passed to technology modules 66, 68. The technology modules 66, 68, which are described in further detail in conjunction with FIG. 4, are designed to process information formatted in a particular manner. For example, one of the technology modules may be a CDMA module and one of the technology modules may be a TDMA module, each of which is configured to encode and decode information according to pre-defined communication formats. As communication protocols evolve or are created, the technology modules 66, 68 may be upgraded to the state of the art via a firmware upgrade to the processor 30. Additionally, more or fewer technology modules than those shown in FIG. 3 could be included in the firmware defined radio 60.

When connectivity is available through two different sources (e.g., from a cellular network and through a wireless home network) and the processor 30 includes a technology module for each source, there may be a pre-defined arbitration scheme through which a technology module 66, 68 is selected for use. For example, if a wireless home network and a cellular network are each available, the processor 30 may be instructed that connectivity to the wireless home network takes precedent over connectivity to the cellular network because the wireless home network has no associated access fee. Accordingly, in such a situation, the technology module corresponding to the wireless home network would be enabled.

The technology modules 66, 68 are coupled to a device interface 70. The device interface 70 produces and receives datagrams, which are network layer 2 communications. The programmatic application program interface (API) exposed by the device interface 70 is a universal network device interface (UNDI). However, wireless UNDI is merely one possible datagram source and sink that may be used. For example, a wired UNDI may be used in the system. In the disclosed example, the device interface 70 receives and outputs information via an UNDI. Accordingly, the information from the technology modules 66, 68 are passed through the UNDI interface. Likewise information coupled to the technology modules 66, 68 from the device interface 70 passes through an UNDI interface.

Depending on the version and type of firmware used by the processor 30, various network protocols 72 may be interfaced to the device interface 70. For example, for extensible firmware interface (EFI) firmware, the network protocol 72 may be a simple network protocol (SNP) layered on top of the UNDI. Additionally, or alternatively, the network protocol 72 may include one or more of a transmission control protocol (TCP), a uniform datagram protocol (UDP) and/or an Internet protocol (IP) layered on the SNP.

To allow a user to interact with the processor 30 in a pre-boot environment, a pre-boot execution environment interface 74 is coupled to the network protocols 72. Alternatively, the pre-boot execution environment interface 74 may be coupled directly to the device interface 70. The pre-boot execution environment interface 74 may be embodied in, for example, a pre-boot execution environment base code interface, commonly referred to as a PXE_BC interface.

In the transmit path of the example firmware defined radio 60, an output module 76 receives information from one or more of the technology modules 66, 68. As described in conjunction with the technology module of FIG. 4, the information to be transmitted by the firmware defined radio 60 is formatted by the technology module 66 or 68 corresponding to the format in which the information is to be transmitted. The output module 76 acts as a firmware output driver that provides the properly-formatted information to a D/A converter 78, which is further coupled to the antenna 22.

The A/D converter 62 and the D/A converter 78 of FIG. 3 may be on board the processor 30 of FIG. 2 or may be separate components therefrom. Although not shown in FIG. 2 or 3, the example processor system 26 and the software defined radio 60 may further include one or more radio frequency (RF) modules that may include mixers configured to mix RF signals down to baseband frequencies. Such RF modules could be firmware controlled to enable selection of the desired RF frequency to be mixed down to baseband.

FIG. 4 reveals additional detail of one example technology module 66, which includes a receive path 90 and a transmit path 110. Although the following description is, for illustrative purposes, provided with respect to the technology module 66 and describes the technology module 66 in reference to particular communication techniques and protocols, those having ordinary skill in the art will readily appreciate that any suitable number of technology modules may be used and each technology module may be configured to handle a different communication format or protocol.

In the receive path 90, samples from the input module 64 are coupled to a demodulator 92, which demodulates the samples of the received waveform into information that is filtered by a filter 94. The demodulator 92 may be, for example, a phase shift keying (PSK) demodulator, a quadrature phase shift keying (QPSK) demodulator, a differential quadrature phase shift keying (DQPSK) demodulator or any other suitable demodulator. A detector 96, including a multiuser detector 98 and a channel estimator 100, processes the filtered information to produce detected bits that are coupled to a channel decoder 102.

As will be readily appreciated, the multiuser detector 98 may, in a CDMA-based system, check the received information for an appropriate code. Alternatively, in a TDMA system, the multiuser detector 98 may determine if a received communication is intended for the processor 30, based on the timing of the received information. The channel estimator 100 corrects the received information for deleterious affects of multipath signal propagation and co-channel interference by, for example, equalizing the received signal.

The channel decoder 102 processes the detected bits from the detector 96 to reverse any channel coding that was performed on the information before the information was transmitted. After the detected bits are channel decoded, a source decoder 104 is used to decode any source coding performed by the transmitter of the information. From the source decoder 104, information is transferred, in UNDI format, to the device interface 70 of FIG. 3.

In the transmit path 110, information, pass through an UNDI, from the device interface 70 (FIG. 3) is passed to a source coder 112, which is a first level of encoding for the information. Source coding may include, for example, trellis coding or any other suitable coding. The source-encoded information is passed to a channel coder 114, which further encodes the information based on predicted distortion that will be encountered as the information is passed through a communication channel. After information for transmission has been source and channel encoded, a spreading/modulator 116 spreads the information for transmission. As will be readily appreciated by those having ordinary skill in the art, spreading may include combining the information for transmission with a high frequency, pseudorandom noise (PN) signal from a PN generator (not shown). The spread information is coupled to the D/A converter 78 of FIG. 3, which further couples the spread information to the antenna 22, via an optional RF block (not shown).

To enable the operation of the firmware defined radio 60 in a pre-boot environment, firmware corresponding to the blocks of FIG. 3 is executed by the processor 30. The example boot process 130 shown in FIG. 5 illustrates one manner in which the firmware defined radio 60 of FIG. 3 may be implemented. The boot process 130 may be carried out when the processor 30 of FIG. 2 receives a reset and/or when the processor 30 is powered-up.

When the boot process 130 begins, the processor 30 is initialized (block 132). Initialization may include, but is not limited to, the preparation of the A/D converter 62 and the D/A converter 78 to receive or generate digital information. Initialization also includes initialization of the basic firmware platform on which the firmware defined radio 60 will operate.

After initialization has completed (block 132), the input and output modules 64, 76 are loaded (block 134). The loading of the input module 64 includes, but is not limited to, the installation of a high-speed sampling interrupt service routine (ISR) that polls the A/D converter 62 to ascertain and buffer samples of an analog signal at sampling period intervals. According to the Nyquist criteria, the sampling rate at which the ISR operates must be at least two times the frequency of the signal being sampled. If the sampling rate of the ISR is selected based on the maximum frequency signal that the A/D converter 62 is likely to receive, the sampling rate will be sufficient for the receipt of any other lower frequency signals.

After the input and output modules 64, 76 are loaded (block 134), the boot process 130 loads the technology module(s) 66, 68 (block 136). As noted previously, the technology module(s) may include, for example, modules for encoding and decoding digital communication information formatted in a number of different ways. For example, there may be one or more modules directed to processing TDMA signals, CDMA signals or signals of any other protocol or format.

After the input/output modules and the technology module(s) have been loaded (blocks 134 and 136), the boot process 130 begins to sample the A/D converter 62 (block 138). After sampling the A/D converter 62 for a period of time, the boot process 130 determines if a wireless signal has been received (block 140). If no wireless signal has been received (block 140), the processor 30 proceeds to boot from conventional media (block 142). Nevertheless, at this point the firmware defined radio 60 of FIG. 3 is functional and is able to receive wireless information, whether or not the firmware defined radio 60 is to boot wirelessly. Alternatively, if a wireless signal has been received (block 140), the boot process 130 determines if booting from the wireless source is desired (block 144). The desire to boot from a wireless device may be manifest by a user making an indication to the firmware via the pre-boot execution environment interface 74 of FIG. 3 or through any other suitable manner, such as a pre-defined software preference. If a wireless boot is not desired (block 144), the processor 30 boots from conventional media (block 142).

If, however, a wireless boot is desired (block 144), a technology module corresponding to the received signal is enabled (block 146). For example, if a CDMA signal is received and may be used to boot the processor 30, a technology module able to decode and encode CDMA signals is enabled. As noted previously, more than one signal may be available from which to boot and, therefore, more than one technology module could possibly be enabled to receive wireless information. In such an instance, the technology module that will be enabled may be dictated by user preference that may be manifest either by an input from the user through the pre-boot execution environment interface 74 of FIG. 3 or through a pre-defined instruction script that sets the priority of technology modules. For example, a priority script may instruct the processor 30 to attempt to boot from a wireless home network before attempting to boot from a cellular network. Accordingly, following the priority with which the technology modules are to be enabled ends with the result of an enabled technology module.

After the appropriate technology module is enabled (block 146), the processor 30 boots wirelessly using information provided from a source corresponding to the enabled technology module (block 148). The wireless boot (block 148) may include reading instructions or loading an operating system based on a command from a source to which the processor 30 is wirelessly connected. As will be readily appreciated by one having ordinary skill in the art, the wireless boot (block 148) may be implemented or carried out with a dynamic boot configuration protocol (DHCP) or a bootstrap protocol/trivial file transfer protocol (BOOTP/TFTP) under the aegis of a pre-boot execution environment.

As an extension, because the networking stack is exposed, other network applications such as, for example, Secure Shell (SSH) and Telnet for network console, may be supported. Additionally, simple network management protocol (SNMP) may be used for network management and hypertext transport protocol (HTTP) may be used as a platform for exporting information via an Internet interface. These modalities could be implemented as part of the wireless boot (block 148 of FIG. 5) or could be implemented in any other desirable manner.

As a further extension, a device module may be used to implement low-level functions, such as ESP mode of Internet security (IPSEC). One of the values of such an extension is that most pre-boot networking IP stacks don't support IPSEC. Accordingly, the addition of a device module that performs IPSEC and produces standard IP packets from the UNDI can provide a back-compatible interface with SNP Drivers and PXE Base Code. This additional IPSEC module could be implemented in FIG. 3 between blocks 66 and 68 and blocks 74 and 68 as a data-to-data transformation module.

Although certain apparatus constructed in accordance with the teachings of the invention have been described herein, the scope of coverage of this patent is not limited thereto. On the contrary, this patent covers all apparatuses, methods and articles of manufacture of the teachings of the invention fairly falling within the scope of the appended claims either literally or under the doctrine of equivalents.

What is claimed is:

1. A machine readable media comprising instructions thereon, wherein the instructions are adapted to be read by a machine in a pre-boot environment to enable the machine to receive data via wireless communications in a pre-boot environment.

2. A machine readable media as defined by claim 1, wherein the instructions define a technology module adapted to convert the received data from a first format into a second format.

3. A machine readable media as defined by claim 1, wherein the first format comprises a digital communications format and the second format comprises a universal network device interface (UNDI) format.

4. A machine readable media as defined by claim 3, wherein the digital communications format comprises at least one of a time division multiple access (TDMA) format and a code division multiple access (CDMA) format.

5. A machine readable media as defined by claim 1, wherein the instructions define a technology module adapted to receive modulated information and to demodulate the modulated information into demodulated information.

6. A machine readable media as defined by claim 5, wherein the instructions cause the machine to perform multiuser detection on the demodulated information.

7. A machine readable media as defined by claim 1, wherein the machine readable media comprises a memory device.

8. A machine readable media as defined by claim 7, wherein the memory device comprises at least one of a flash memory and a read only memory.

9. A machine readable media as defined by claim 1, further comprising instructions thereon, wherein the instructions are adapted to be read by the machine in a pre-boot environment to enable the machine to generate data for transmission, to encode the data for transmission and to modulate the data for transmission into modulated transmission data.

10. A machine readable data as defined by claim 9, wherein the modulated transmission data is formatted according to one of a time division multiple access (TDMA) format and a code division multiple access (CDMA) format.

11. A method of receiving data via wireless communications in a pre-boot environment, the method comprising:
sampling received data to produce modulated data in the pre-boot environment;
demodulating the modulated data to produce demodulated data in the pre-boot environment;
performing multiuser detection on the demodulated data in the pre-boot environment; and
decoding the demodulated data to produce network data.

12. A method as defined by claim 11, wherein the network data comprises data formatted in a uniform network device interface (UNDI) format.

13. A method as defined by claim 11, wherein the received data is formatted according to one of a code division multiple access (CDMA) format and a time division multiple access (TDMA) format.

14. A method as defined by claim 11, further comprising encoding data for transmission and modulating the data for transmission into modulated transmission data.

15. A method as defined by claim 14, wherein the modulated transmission data is formatted according to one of a time division multiple access (TDMA) format and a code division multiple access (CDMA) format.

16. A communication system comprising:
an antenna;
an analog-to-digital converter coupled to the antenna;
a firmware defined input module configured to sample input data from the analog-to-digital converter in a pre-boot environment and to generate modulated data;
a firmware defined technology module configured to receive the modulated data in the pre-boot environment and to produce network interface data.

17. A communication system as defined by claim 16, wherein the modulated data comprises a digital communications format and the network interface data comprises a universal network device interface (UNDI) format.

18. A communication system as defined by claim 17, wherein the digital communications format comprises one of a time division multiple access (TDMA) format and a code division multiple access (CDMA) format.

19. A communications system as defined by claim 16, wherein the firmware defined technology module is adapted to convert the modulated data into demodulated data and to perform multiuser detection on the demodulated information.

20. A communications system as defined by claim 16, further comprising:
a firmware defined output module coupled to the technology module, wherein the firmware defined output module is configured to receive data for transmission from the technology module, to encode the data for transmission and to modulate the data for transmission into modulated transmission data; and
a digital-to-analog converter coupled to the firmware defined technology module, wherein the digital-to-analog converter is configured to receive the modulated transmission data, to generate an analog signal for transmission and to couple the analog signal for transmission to the antenna.

21. A method of wirelessly booting a machine, the method comprising:
loading an input module in a pre-boot environment;
loading a technology module in the pre-boot environment;
sampling data from a data source via the input module;
determining if a wireless signal is present in the data from the data source;
enabling the technology module to interpret the received signal; and
booting an operating system based on information provided in the received signal.

22. A method as defined by claim 21, wherein the wireless signal comprises a digital communications signal.

23. A method as defined by claim 21, wherein the technology module is configured to demodulate and decode the wireless signal.

24. A method as defined by claim 21, wherein the data source comprises an analog-to-digital converter.
